(19) United States
(12) Patent Application Publication
(10) Pub. No.: US 2002/0159184 A1
(43) Pub. Date: Oct. 31, 2002

(54) Spindle motor driving method, spindle motor driving circuit, magnetic disk driving method, and magnetic disk device

(76) Inventor: Norio Shigematsu, Onsen-gun (JP)

Correspondence Address: Parkhurst & Wendel, 1421 Prince Street, Suite 210, Alexandria, VA, 22314-2805, US

(21) Appl. No.: 10/018,218

(22) PCT Filed: Mar. 23, 2001
(86) PCT No.: PCT/JP01/02377

(30) Foreign Application Priority Data
Apr. 20, 2000 (JP) 2000-118785

(51) Int. Cl. G11B 15/18; G11B 17/00; G11B 19/02; G11B 15/46

(52) U.S. Cl. 360/71; 360/69

(57) ABSTRACT

A single device, of which structural size is minimized, allows it to provide a method of driving a spindle motor, a spindle motor driving circuit, a method of driving a magnetic disk, and a magnetic disk device, each for driving a spindle motor in an optimal driving mode or with optimal driving characteristics according to a command from a higher level system or a type of an application in use. According to the command from the higher level system, a driving mode switching unit in a spindle motor driving circuit switches driving of the spindle motor between a pulse-width modulation driving mode by a pulse-width modulation driving means and a linear driving mode by a linear driving means. Thus, a single spindle motor driving circuit can provide driving in a driving mode suitable for an intended use.

### TECHNICAL FIELD

The present invention relates to a method of driving a spindle motor, which is composed of a permanent magnet rotor and a coil stator, a driving circuit therefor, a method of driving a magnetic disk that rotationally drives a magnetic disk with the spindle motor, and a magnetic disk device.

### BACKGROUND ART

Conventionally, a spindle motor, which has a permanent magnet as a rotor and a coil for rotationally driving the rotor as a stator, generates rotational torque by supplying current to the stator coil. For example, in a case where the stator coil consists of three phases, current is applied to two coils in a predetermined order and phases are switched so as to maintain the rotation.

As a method of driving the spindle motor thus configured, a pulse-width modulation (PWM) driving mode or a linear driving mode is often used. In the former pulse-width modulation (PWM) driving mode, an output stage for supplying driving current to the spindle motor is completely subjected to a switching operation. Meanwhile, in the latter linear driving mode, the output stage for supplying driving current to the spindle motor is linearly operated in a continuous manner.

In the past, a spindle motor driving circuit for driving a spindle motor in such driving modes has been configured such that only one of the pulse-width modulation (PWM) driving mode and the linear driving mode is possible. Hence, one of the driving modes is used in a fixed manner for driving the spindle motor.

However, in the above conventional spindle motor driving circuit, for example, when the spindle motor is driven in the pulse-width modulation (PWM) driving mode, power consumption can be reduced because the output stage is completely subjected to switching operation. However, switching noise caused by a complete switching operation increases the rotation sound of the spindle motor.

Meanwhile, when the spindle motor is driven in the linear driving mode, since the output stage is linearly operated in a continuous manner, switching noise is suppressed and the rotation sound of the spindle motor can be reduced. However, since driving current is supplied continuously, power consumption rises due to the driving current.

Therefore, conventionally, in a case where the spindle motor driving circuit is used, in which only one of the pulse-width modulation (PWM) driving mode and the linear driving mode is used in a fixed manner to drive the spindle motor, the spindle motor driving circuit using the pulse-width modulation (PWM) driving mode is necessary when priority is placed on power consumption, and the spindle motor driving circuit using the linear driving mode is necessary when priority is placed on reduction of the rotation sound of the spindle motor. Thus, it is necessary to prepare spindle motor driving circuits separately according to required specifications for each use.

Further, likewise, in a magnetic disk device for recording and reproducing a variety of information on a magnetic disk by driving the spindle motor using the above spindle motor driving circuit and rotationally driving the magnetic disk, in the case of a computer and so on, in which rotation sound of the spindle motor is not a serious problem, it is necessary to use a magnetic disk device using a spindle motor driving circuit which drives a spindle motor according to the pulse-width modulation (PWM) driving mode. In the case of audiovisuals and so on, in which rotation sound is a serious problem, it is necessary to use a magnetic disk device using a spindle motor driving circuit which drives a spindle motor according to the linear driving mode. Thus, it is necessary to separately prepare magnetic disk devices using the spindle motor driving circuits for each uses.

The present invention is devised to solve the above conventional problems and provides a method of driving a spindle motor, a spindle motor driving circuit, a method of driving a magnetic disk, and a magnetic disk device, whereby according to a command from a higher level system and a type of an application in use, it is possible to automatically and readily switch and select a driving mode such as the pulse-width modulation driving mode and the linear driving mode or driving characteristics such as a through rate in the pulse-width modulation driving mode, and with a single device whose increase in size is minimized, it is possible to drive the spindle motor in the most suitable driving mode or with the most suitable driving characteristics according to a command from a higher level system or a type of an application in use without necessity for preparing a plurality of devices.

### DISCLOSURE OF INVENTION

In order to solve the above problems, a method of driving a spindle motor, a spindle motor driving circuit, a method of driving a magnetic disk, and a magnetic disk device of the present invention are characterized in that it is possible to provide driving according to a driving mode suitable for an intended use with a single spindle motor driving circuit by switching the spindle motor between the pulse-width modulation driving mode and the linear driving mode according to a command from a higher level system or a type of an application in use.

Further, it is possible to provide driving according to a driving mode suitable for an intended use with a single spindle motor driving circuit by switching a through rate while the spindle motor is driven in the pulse-width modulation driving mode according to a command from the higher level system or a type of the application in use.

With this arrangement, it is possible to automatically and readily switch and select a driving mode such as the pulse-width modulation driving mode and the linear driving mode or driving characteristics such as a through rate in the pulse-width modulation driving mode according to a command from the higher level system or a type of the application in use, and with a single device whose increase in size is minimized, it is possible to drive the spindle motor in the most suitable driving mode or with the most suitable driving characteristics according to a command from the higher level system or a type of the application in use without any necessity for a plurality of devices.

Moreover, a method of switching the driving modes or driving characteristics can be provided as a computer program.

Therefore, it is possible to realize the method of switching the driving modes and driving characteristics of the spindle motor simply by exchanging the recording mediums for recording a program. And it is possible to automatically and readily switch and select driving modes or characteristics suitable for an intended use according to a command from the higher level system or a type of the application in use without any increase in size, thereby achieving the above-mentioned effect.

A method of driving a spindle motor according to a first aspect of the present invention, by which a spindle motor having a permanent magnet as a rotor and a coil for rotationally driving the rotor as a stator is rotationally driven by supplying driving current to the coil, characterized in that when driving current for rotational driving is supplied to the spindle motor, a driving mode is switched and selected between the pulse-width modulation driving mode and the linear driving mode according to a command from the higher level system, and the driving current corresponding to the switched and selected driving mode of the pulse-width modulation driving mode and the linear driving mode is supplied to the spindle motor. Moreover, switching and selecting is made by a serial port according to a command from the higher level system that is received via a serial interface.

A spindle motor driving circuit according to a first aspect is provided with an output stage which supplies driving current for rotational driving to the spindle motor, and driving mode switching means for switching and selecting a driving mode between the pulse-width modulation driving mode and the linear driving mode according to a command from the higher level system. The output stage is configured such that the driving current, which corresponds to the driving mode switched and selected from the pulse-width modulation driving mode and the linear driving mode by the driving mode switching means, is supplied to the spindle motor. Further, the driving mode switching means is provided in which switching and selecting is made by the serial port according to a command from the higher level system, the command being received via the serial interface.

A magnetic disk device according to a first aspect, in which a magnetic disk is rotationally driven to record and reproduce a variety of information on the magnetic disk serving as a recording medium of the variety of information, is provided with the spindle motor driving circuit. The spindle motor driving circuit is configured such that the driving of the output stage is switched between the pulse-width modulation driving mode and the linear driving mode by the driving mode switching means according to a command from the higher level system. Also, the spindle motor driving circuit is configured such that a command from the higher level system that is received via the serial interface is sent to the serial port and the driving of the output stage is switched between the pulse-width modulation driving mode and the linear driving mode by the serial port according to the command.

According to the above method and configurations, the driving of the output stage is switched between the pulse-width modulation driving mode and the linear driving mode according to a command from the higher level system. Thus, a single spindle motor driving circuit can provide driving in a driving mode suitable for an intended use. Further, a command from the higher level system is received in the serial interface, the command is sent to the serial port, and the above switching is made in the serial port according to the command from the higher level system.

A method of driving a spindle motor according to a second aspect, by which a spindle motor having a permanent magnet as a rotor and a coil for rotationally driving the rotor as a stator is rotationally driven by supplying driving current to the coil, characterized in that when driving current for rotational driving is supplied to the spindle motor, a high and a low through rates of the pulse-width modulation driving mode are switched and selected as driving characteristics according to a command from the higher level system, and the driving current, which corresponds to the switched and selected through rate from the high and low through rates, is supplied to the spindle motor. Moreover, high and low through rates are switched and selected by the serial port according to a command from the higher level system that is received via the serial interface.

A spindle motor driving circuit according to a second aspect is provided with an output stage which supplies driving current for rotational driving to the spindle motor, and through rate switching means for switching and selecting high and low through rates of the pulse-width modulation driving mode as driving characteristics according to a command from the higher level system. The output stage is configured such that the driving current, which corresponds to a through rate switched and selected from the high and low through rates by the through rate switching means, is supplied to the spindle motor. Also, the through rate switching means is constituted by a serial port according to a command from the higher level system that is received via a serial interface.

A magnetic disk device according to a second aspect, in which a magnetic disk is rotationally driven to record and reproduce a variety of information on the magnetic disk serving as a recording medium of the variety of information, is provided with the spindle motor driving circuit. The spindle motor driving circuit is configured such that a through rate of the output stage driven in the pulse-width modulation driving mode is switched by the through rate switching means according to a command from the higher level system. Moreover, the spindle motor driving circuit is configured such that a command from the higher level system is sent to the serial port, the command being received via the serial interface, and a through rate of the output stage driven in the pulse-width modulation driving mode is switched by the serial port according to the command.

According to the above method and configurations, a command from the higher level system is received in the serial interface, the command is sent to the serial port, and a through rate is switched in the serial port according to the command from the higher level system while the output stage is driven in the pulse-width modulation driving mode. Thus, a single spindle motor driving circuit can provide driving in a driving mode suitable for an intended use. Moreover, a through rate is switched according to a command from the higher level system while the output stage is driven in the pulse-width modulation driving mode. Hence, a single spindle motor driving circuit can provide driving in a driving mode suitable for an intended use.

A method of driving a magnetic disk according to a third aspect, by which driving current is supplied to a coil of a spindle motor having a permanent magnet as a rotor and the coil for rotationally driving the rotor as a stator and a magnetic disk is rotationally driven by the spindle motor in order to record or reproduce a variety of information on the magnetic disk serving as a recording medium of the variety of information, characterized in that when driving current for rotational driving is supplied to the spindle motor, a driving mode is switched and selected according to a type of an application in use such that driving is made in the pulse-width modulation driving mode for a use in which a rotation sound of the spindle motor is not a serious problem for the application and driving is made in the linear driving mode for a use in which the rotation sound of the spindle motor is a serious problem for the application. The driving current corresponding to a switched and selected driving mode from the pulse-width modulation driving mode and the linear driving mode is supplied to the spindle motor.

A magnetic disk device according to a third aspect, which is provided with a spindle motor having a permanent magnet as a rotor and a coil for rotationally driving the rotor as a stator, a spindle motor driving circuit for rotationally driving the spindle motor by supplying driving current to the coil, and driving mode determining means for determining a driving mode of the spindle motor driving circuit, characterized in that the magnetic disk is rotationally driven by the spindle motor in order to record or reproduce a variety of information on the magnetic disk serving as a recording medium of the variety of information. The driving mode determining means is configured so as to determine a driving mode according to a type of an application in use such that driving is made in the pulse-width modulation driving mode for a use in which a rotation sound of the spindle motor is not a serious problem for the application and driving is made in the linear driving mode for a use in which the rotation sound of the spindle motor is a serious problem for the application. The spindle motor driving circuit is provided with an output stage which supplies driving current for rotational driving to the spindle motor and driving mode switching means for switching and selecting the driving mode according to the determination of the driving mode determining means. The output stage is configured such that the driving current, which corresponds to the driving mode switched and selected from the pulse-width modulation driving mode and the linear driving mode by the driving mode switching means, is supplied to the spindle motor.

A recording medium according to a third aspect is configured such that a program is recorded for supplying software as means for determining a driving mode of the magnetic disk device, the software switching a driving mode of the spindle motor according to an application in use such that the spindle motor is driven in the pulse-width modulation driving mode for a use in which a rotation sound is not a serious problem and the spindle motor is driven in the linear driving mode for a use in which the rotation sound is a serious problem.

According to the above method and configurations, a driving mode of the spindle motor is switched according to an application in use such that the spindle motor is driven in the pulse-width modulation driving mode for a use in which a rotation sound is not a serious problem and the spindle motor is driven in the linear driving mode for a use in which the rotation sound is a serious problem. Thus, a single magnetic disk device can provide driving in a driving mode suitable for an intended use.

A method of driving a magnetic disk according to a fourth aspect, by which in order to record or reproduce a variety of information on the magnetic disk serving as a recording medium of the variety of information, driving current is supplied to a coil of a spindle motor having a permanent magnet as a rotor and the coil for rotationally driving the rotor as a stator and the magnetic disk is rotationally driven by the spindle motor, characterized in that when driving current for rotational driving is supplied to the spindle motor, high and low through rates of the pulse-width modulation driving mode are switched and selected as driving characteristics according to a type of an application in use such that driving is made in the pulse-width modulation driving mode of a high through rate for a use in which a rotation sound of the spindle motor is not a serious problem for the application and driving is made in the pulse-width modulation driving mode of a low through rate for a use in which the rotation sound of the spindle motor is a serious problem for the application, and the driving current, which corresponds to the through rate switched and selected from the high through rate and the low through rate, is supplied to the spindle motor.

A magnetic disk device according to a fourth aspect, which is provided with the spindle motor having a permanent magnet as a rotor and the coil for rotationally driving the rotor as a stator, a spindle motor driving circuit for rotationally driving the spindle motor by supplying driving current to the coil, and through rate determining means for determining driving characteristics of the spindle motor driving circuit, characterized in that the magnetic disk is rotationally driven by the spindle motor in order to record or reproduce a variety of information on the magnetic disk serving as a recording medium of the variety of information. The through rate determining means is configured so as to determine if a through rate of the pulse-width modulation driving mode is high or low as driving characteristics according to a type of an application in use such that driving is made in the pulse-width modulation driving mode of a high through rate a rotation sound of the spindle motor is not a serious problem for the application and driving is made in the pulse-width modulation driving mode of a low through rate for a use in which the rotation sound of the spindle motor is a serious problem for the application. The spindle motor driving circuit is provided with an output stage which supplies driving current for rotational driving to the spindle motor and through rate switching means for switching and selecting high and low switching rates of the pulse-width modulation driving mode as the driving characteristics according to the determination of the through rate determining means. The output stage is configured such that the driving current, which corresponds to a through rate switched and selected from the high through rate and the low through rate by the through rate switching means, is supplied to the spindle motor.

A recording medium according to a fourth aspect is configured such that a program is recorded for supplying software as through rate means of the magnetic disk device. The software switches a through rate of the output stage, which is driven in the pulse-width modulation driving mode, according to an application in use such that the spindle motor is driven in the pulse-width modulation driving mode of a high through rate for a use in which a rotation sound is not a serious problem and the spindle motor is driven in the pulse-width modulation driving mode of a low through rate for a use in which the rotation sound is a serious problem.

According to the above method and configurations, a through rate is switched while the spindle motor is driven in the pulse-width modulation driving mode according to an application in use such that the spindle motor is driven in the pulse-width modulation driving mode of a high through rate for a use in which a rotation sound is not a serious problem and the spindle motor is driven in the pulse-width modulation driving mode of a low through rate for a use in which the rotation sound is a serious problem. Thus, a single magnetic disk device can provide driving in a driving mode suitable for an intended use.

### BRIEF DESCRIPTION OF DRAWINGS

FIG. 1 is a block diagram showing a configuration of a spindle motor driving circuit in a magnetic disk device according to Embodiment 1 of the present invention;

FIG. 2 is a block diagram showing a configuration of a spindle motor driving circuit in a magnetic disk device according to Embodiment 2 of the present invention;

FIG. 3 is a waveform chart showing driving current of the spindle motor in the magnetic disk device according to Embodiment 1 of the present invention;

FIG. 4 is a waveform chart showing driving current of the spindle motor in the magnetic disk device according to Embodiment 2 of the present invention;

FIG. 5 is a block diagram showing a configuration of a spindle motor driving control section in a magnetic disk device according to Embodiment 3 of the present invention; and

FIG. 6 is a block diagram showing a configuration of a spindle motor driving control section in a magnetic disk device according to Embodiment 4 of the present invention.

### BEST MODE FOR CARRYING OUT THE INVENTION

Referring to the drawings, a method of driving a spindle motor, a spindle motor driving circuit, a method of driving a magnetic disk, and a magnetic disk device that represent embodiments of the present invention will be described in detail below.

### EMBODIMENT 1

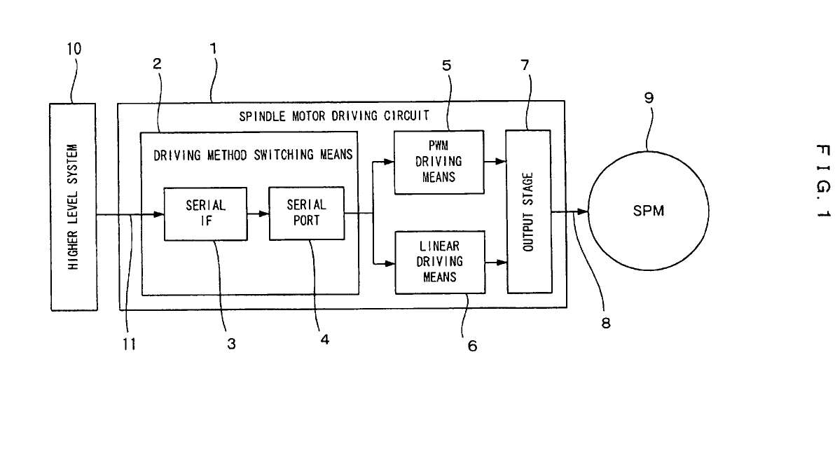

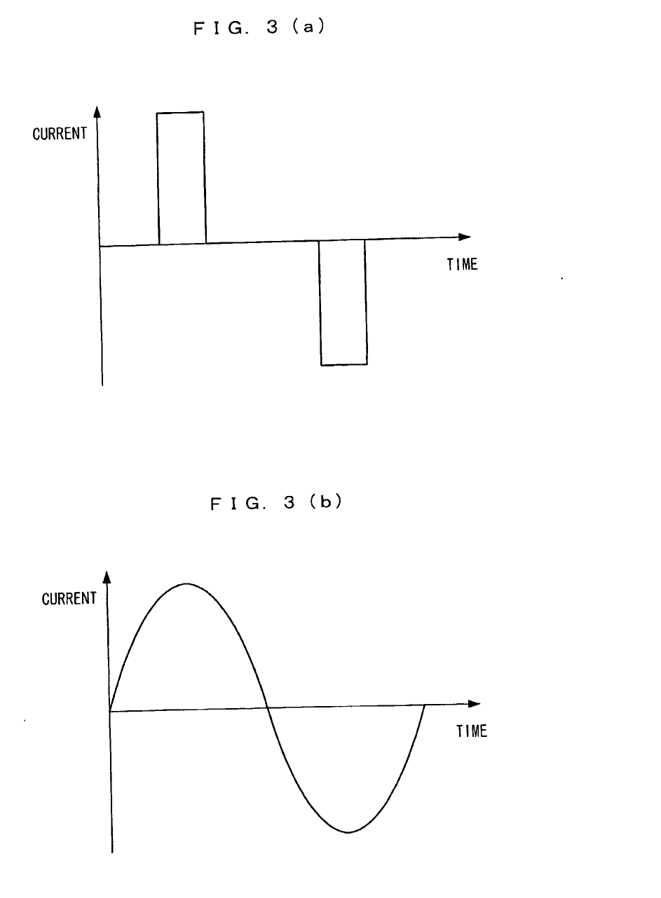

Referring to FIGS. 1 and 3, Embodiment 1 will be described.

FIG. 1 is a block diagram showing the configuration of a spindle motor driving circuit used in a magnetic disk device according to Embodiment 1. FIG. 3 is a waveform chart showing driving current of a spindle motor used in the magnetic disk device of Embodiment 1.

First, in FIG. 1, in a spindle motor driving circuit 1, for example, in order to rotate a typical spindle motor (SPM) 9 having a permanent magnet as a rotor and a driving coil as a stator, when a driving coil has three phases, a driving current 8 is supplied every two coils in a predetermined order to switch the phases.

The spindle motor driving circuit 1 is constituted by an output stage 7 for supplying the driving current 8 to rotate a spindle motor 9, pulse-width modulation (PWM) driving means 5 for driving the output stage 7 by a pulse-width modulation (PWM) driving mode, linear driving means 6 for driving the output stage 7 by a linear driving mode, and driving mode switching means 2 for switching the driving of the output stage 7 between the pulse-width modulation (PWM) driving mode and the linear driving mode. Moreover, the driving mode switching means 2 is constituted by a serial interface (serial IF) 3 and a serial port 4.

A higher level system 10 transmits a driving mode command 11, which instructs whether the output stage 7 should be driven in the pulse-width modulation (PWM) driving mode or the linear driving mode, to the serial port 4 via the serial interface 3. The serial port 4 drives the output stage 7 by the pulse-width modulation (PWM) driving means 5 or the linear driving means 6 according to the driving mode command 11 from the higher level system 10. The output stage 7 supplies the driving current 8 to the spindle motor 9 according to the selected driving means and maintains the rotation of the spindle motor 9.

FIG. 3(a) shows a current waveform when the output stage 7 is driven in the pulse-width modulation (PWM) driving mode. For example, in a computer and so on, in which rotation sound is not a serious problem, when driving is made with a current waveform of the pulse-width modulation (PWM) driving mode that is shown in FIG. 3(a), the output stage 7 can be completely subjected to a switching operation. Hence, power consumption can be reduced.

Moreover, FIG. 3(b) shows a current waveform when the output stage 7 is driven in the linear driving mode. In the case of audiovisuals and so on, in which rotation sound is a serious problem, when driving is made with the current waveform of the linear driving mode shown in FIG. 3(b), since the output stage 7 is linearly operated, it is possible to suppress switching noise, which occurs in the complete switching operation, and to reduce rotation sound of the spindle motor 9.

As described above, according to Embodiment 1, the driving of the output stage 7 is switched between the pulse-width modulation driving mode and the linear driving mode according to a command from the higher level system. Thus, a single spindle motor driving circuit can provide driving according to a driving mode suitable for an intended use.

Besides, the serial interface receives a command from the higher level system, the command is sent to the serial port, and the driving of the output stage is switched between the pulse-width modulation driving mode and the linear driving mode according to the command from the higher level system. Hence, a single spindle motor driving circuit can provide driving according to a driving mode suitable for an intended use.

### EMBODIMENT 2

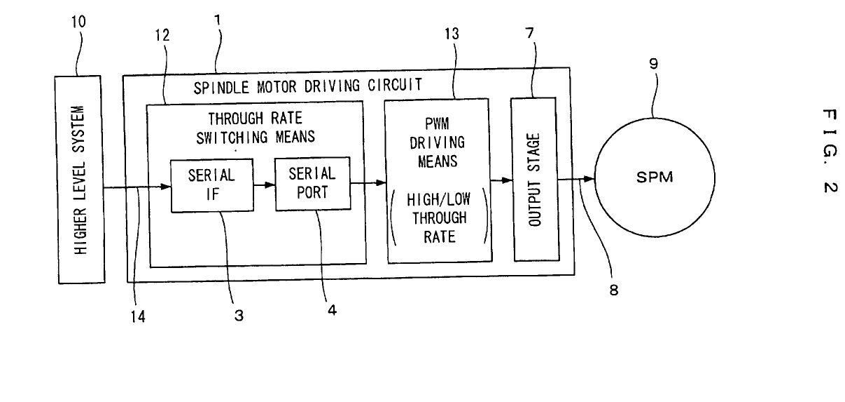

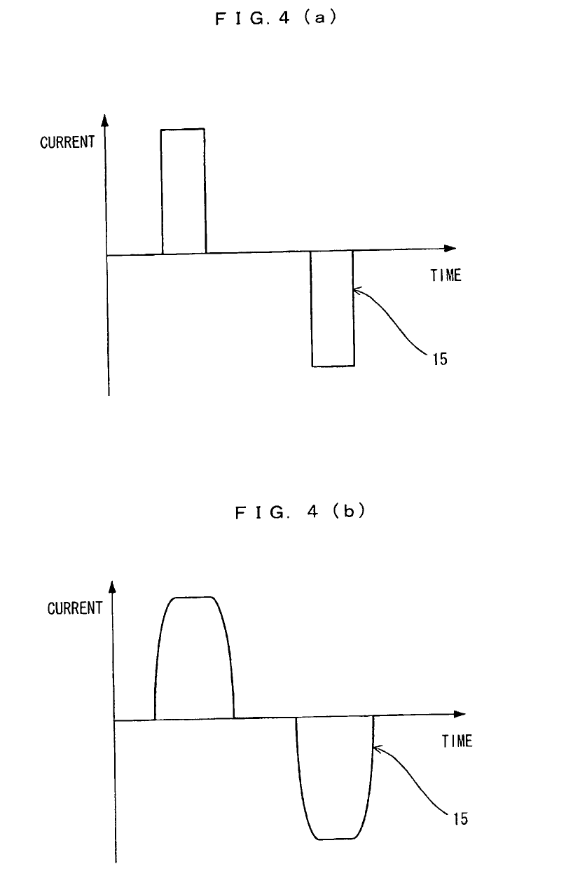

Referring to FIGS. 2 and 4, Embodiment 2 will be described.

FIG. 2 is a block diagram showing the configuration of a spindle motor driving circuit used in a magnetic disk device of Embodiment 2. FIG. 4 is a waveform chart showing driving current of a spindle motor used in the magnetic disk device of Embodiment 2.

First, in FIG. 2, in order to rotate a typical spindle motor (SPM) 9 having a permanent magnet as a rotor and a driving coil as a stator, for example, when the driving coil has three phases, a spindle motor driving circuit 1 applies a driving current 8 every two coils in a predetermined order to switch the phases.

The spindle motor driving circuit 1 is constituted by an output stage 7 which supplies the driving current 8 for rotating the spindle motor 9, pulse-width modulation (PWM) driving means 13 which can change a through rate while the output stage 7 is driven in the pulse-width modulation (PWM) driving mode, and through rate switching means 12 for switching the driving of the output stage 7 between the pulse-width modulation (PWM) driving mode of a high through rate and the pulse-width modulation (PWM) driving mode of a low through rate. Furthermore, the through rate switching means 12 is constituted by a serial interface 3 and a serial port 4.

A higher level system 10 transmits a through rate value command 14, which instructs a through rate value for driving the output stage 7 by the pulse-width modulation (PWM) driving mode, to the serial port 4 via the serial interface 3. The serial port 4 drives the output stage 7 by the pulse-width modulation (PWM) driving mode of the instructed through rate value according to the through rate value command 14 from the higher level system 10. The output stage 7 supplies the driving current 8 of the instructed through rate value to the spindle motor 9 and maintains the rotation of the spindle motor 9.

FIG. 4(a) shows a current waveform in a case where a through rate is high when the output stage 7 is driven in the pulse-width modulation (PWM) driving mode. For example, in the case of a computer and so on, in which rotation sound is not a serious problem, when driving is made with a high through rate by the pulse-width modulation (PWM) driving mode shown in FIG. 4(a), the output stage 7 is rapidly switched at a switching point 15. Thus, power consumption can be reduced.

FIG. 4(b) shows a current waveform in a case where a through rate is low when the output stage 7 is driven in the pulse-width modulation (PWM) driving mode. For example, in the case of audiovisuals and so on, in which rotation sound is a serious problem, when driving is made with a low through rate by the pulse-width modulation (PWM) driving mode show in FIG. 4(b), the output stage 7 is slowly switched at a switching point 15. Hence, it is possible to suppress switching noise, which occurs in the high-speed switching, and to reduce rotation sound of the spindle motor 9.

According to Embodiment 2, a through rate is switched according to a command from the higher level system while the output stage is driven in the pulse-width modulation driving mode. Hence, a single spindle motor driving circuit can provide driving according to a driving mode suitable for the use.

Further, a command form the higher level system is received in the serial interface, the command is sent to the serial port, and a through rate is switched while the output stage is driven in the pulse-width modulation driving mode according to the command from the higher level system in the serial port. Thus, a single spindle motor driving circuit can provide driving according to a driving mode suitable for each use.

### EMBODIMENT 3

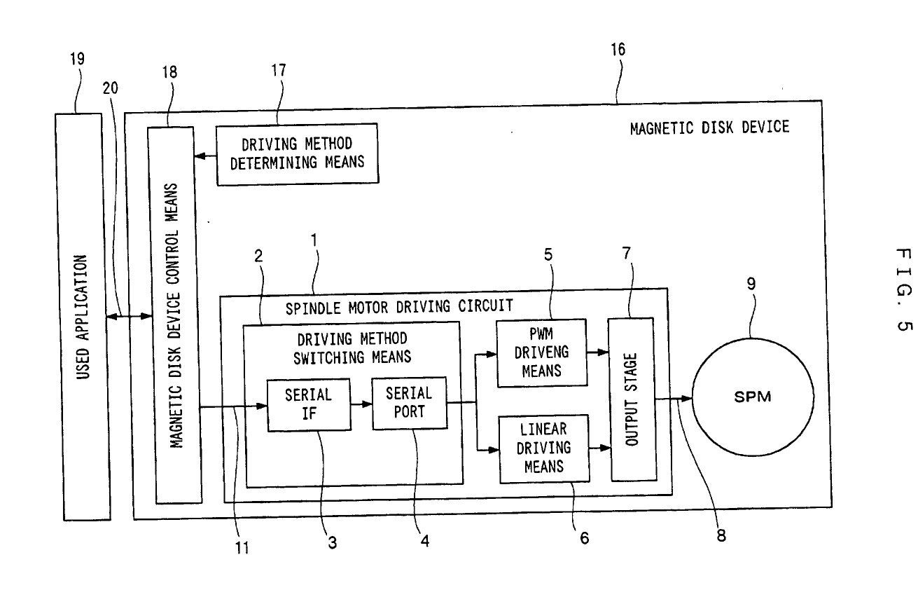

Referring to FIG. 5, Embodiment 3 will be described.

FIG. 5 is a block diagram showing the configuration of a spindle motor driving control section in a magnetic disk device of Embodiment 3. In FIG. 5, a magnetic disk device 16 is connected via an application 19 in use and an interface 20, and data is exchanged via the interface 20.

In order to rotate a spindle motor 9 having a permanent magnet as a rotor and a driving coil as a stator, when the driving coil has three phases, a spindle motor driving circuit 1 of the magnetic disk device 16 applies a driving current 8 every two coils in a predetermined order to switch the phases.

The spindle motor driving circuit 1 is constituted by an output stage 7 which supplies the driving current 8 for rotating the spindle motor 9, pulse-width modulation (PWM) driving means 5 for driving the output stage 7 by a pulse-width modulation (PWM) driving mode, linear driving means 6 for driving the output stage 7 by a linear driving mode, driving mode switching means 2 for switching the driving of the output stage 7 between the pulse-width modulation (PWM) driving mode and the linear driving mode, driving mode determining means 17 for determining whether the output stage 7 should be driven in the pulse-width modulation (PWM) driving mode or the linear driving mode, and magnetic disk device control means 18 for transmitting a driving mode command 11, which is determined by the driving mode determining means 17, to the driving mode switching means 2. Further, the driving mode switching means 2 is constituted by a serial interface 3 and a serial port 4.

When the application 19 in use is a computer and so on, in which rotation sound is not a serious problem, the driving mode determining means 17 determines that the output stage 7 should be driven in the pulse-width modulation (PWM) driving mode according to the specification of the application 19 in use, and sends the driving mode command 11 to the driving mode switching means 2 via the magnetic disk device control means 18.

The serial interface 3 in the driving mode switching means 2 sends the driving mode command 11 to the serial port 4, and the serial port 4 drives the output stage 7 by the pulse-width modulation (PWM) driving means 5 according to the driving mode command 11. The output stage 7 supplies the driving current 8 to the spindle motor 9 according to the selected pulse-width modulation (PWM) driving mode and maintains the rotation of the spindle motor 9.

Meanwhile, when the application 19 in use is used for audiovisuals and so on, in which rotation sound is a serious problem, the driving mode determining means 17 determines that the output stage 7 should be driven in the linear driving mode according to the specification of the application 19 in use and sends the driving mode command 11 to the driving mode switching means 2 via the magnetic disk device control means 18.

The serial interface 3 in the driving mode switching means 2 sends the driving mode command 11 to the serial port 4, and the serial port 4 drives the output stage 7 by the linear driving means 6 according to the driving mode command 11. The output stage 7 supplies the driving current 8 to the spindle motor 9 according to the selected linear driving mode and maintains the rotation of the spindle motor 9.

According to Embodiment 3, the driving mode of the spindle motor is switched according to an application in use as follows: the spindle motor is driven in the pulse-width modulation driving mode for a use in which a rotation sound is not a serious problem, and the spindle motor is driven in the linear driving mode for a use in which the rotation sound is a serious problem. Thus, a single magnetic disk device can provide driving according to a driving mode suitable for each use.

### EMBODIMENT 4

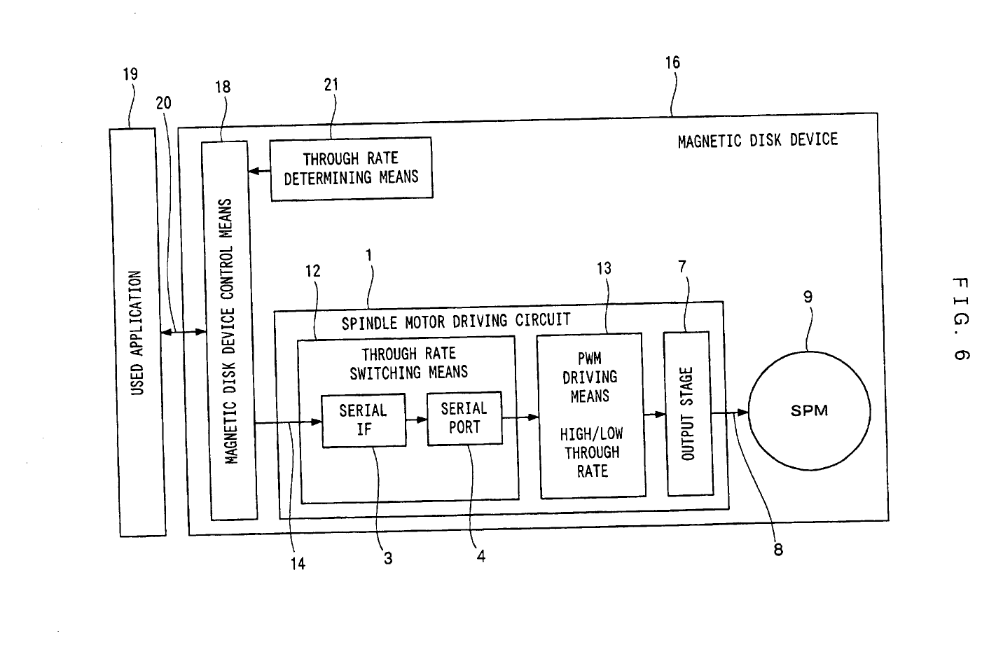

Referring to FIG. 6, Embodiment 4 will be described.

FIG. 6 is a block diagram showing the configuration of a spindle motor driving control section in a magnetic disk device of Embodiment 4. In FIG. 6, a magnetic disk device 16 is connected via an application 19 in use and an interface 20, and data is exchanged via the interface 20.

In a spindle motor driving circuit 1 of the magnetic disk device 16, in order to rotate the spindle motor 9 having a permanent magnet as a rotor and a driving coil as a stator, when the driving coil has three phases, a driving current 8 is supplied every two coils in a predetermined order to switch the phases.

The spindle motor driving circuit 1 is constituted by an output stage 7 which supplies the driving current 8 for rotating the spindle motor 9, pulse-width modulation (PWM) driving means 13 which can change a through rate while the output stage 7 is driven in the pulse-width modulation (PWM) driving mode, through rate switching means 12 for switching the driving of the output stage 7 between the pulse-width modulation (PWM) driving mode of a high through rate and the pulse-width modulation (PWM) driving mode of a low through rate, through rate determining means 21 for determining a through rate value of the output stage 7, and magnetic disk device control means 18 for transmitting a through rate value command 14 determined by the through rate determining means 21 to the through rate switching means 12. Moreover, the through rate switching means 12 is constituted by a serial interface 3 and a serial port 4.

When the application 19 is used for a computer and so on, in which rotation sound is not a serious problem, the through rate determining means 21 determines that the output stage 7 should be driven with a high through rate by the pulse-width modulation (PWM) driving mode according to the specification of the application 19 in use, and the through rate value command 14 is sent to the through rate switching means 12 via the magnetic disk device control means 18.

The serial interface 3 in the through rate switching means 12 sends the through rate value command 14 to the serial port 4, and the serial port 4 drives the output stage 7 with a high through rate according to the through rate value command 14. The output stage 7 is driven in the pulse-width modulation (PWM) driving mode and supplies the driving current 8, which corresponds to the high-through rate driving, to the spindle motor 9 and the maintains the rotation of the spindle motor 9.

Meanwhile, when the application 19 is used for audiovisuals and so on, in which rotation sound is a serious problem, the through rate determining means 21 determines that the output stage 7 should be driven with a low through rate by the pulse-width modulation (PWM) driving mode according to the specification of the application 19 in use, and sends the through rate value command 14 to the through rate switching means 12 via the magnetic disk device control means 18.

The serial interface 3 in the through rate switching means 12 sends the through rate value command 14 to the serial port 4, and the serial port 4 drives the output stage 7 with a low through rate according to the through rate value command 14. The output stage 7 is driven in the pulse-width modulation (PWM) driving mode and supplies the driving current 8, which corresponds to the low-through rate driving, to the spindle motor 9 and maintains the rotation of the spindle motor 9.

As described above, with the above Embodiments, according to a command from a higher level system or a type of an application in use, it is possible to automatically and readily switch and select the driving mode such as the pulse-width modulation driving mode and the linear driving mode and driving characteristics such as a through rate of the pulse-width modulation driving mode, and with a single device whose increase in size is minimized, it is possible to drive the spindle motor in the most suitable driving mode or with the most suitable driving characteristics according to the command from the higher level system or the type of the application in use, without any necessity for a plurality of devices.

Besides, in the above Embodiments, the means for switching the driving modes or driving characteristics of the spindle motor is realized by hardware. The method for switching the driving modes or driving characteristics can be also provided as software, which uses a recording medium for recording a program, such that the switching method can be realized based on a computer program being executable by a computer. The recording medium can record a program which supplies software for switching the driving modes or driving characteristics of the spindle motor according to the application in use such that the spindle motor is driven in the pulse-width modulation driving mode for a use in which a rotation sound is not a serious problem and the spindle motor is driven in the linear driving mode for a use in which the rotation sound is a serious problem, or the spindle motor is driven in the pulse-width modulation driving mode of a high through rate for a use in which a rotation sound is not a serious problem and the spindle motor is driven in the pulse-width modulation driving mode of a low through rate for a use in which the rotation sound is a serious problem.

As described above, since the method for switching the driving modes and driving characteristics of the spindle motor is provided as a computer program, it is possible to realize the method of switching the driving modes and driving characteristics of the spindle motor simply by exchanging the recording mediums for recording a program, and it is possible to automatically and readily switch and select a driving mode or characteristics suitable for an intended use according to a command from the higher level system or a type of the application in use without increasing a size, thereby achieving the above-mentioned effect.

As the recording medium, it is possible to adopt any kind of a data recording device including a floppy disk, a CD-ROM, a DVD, a magneto-optical disk, a removable hard disk, and a flash memory.

According to Embodiment 4, it is possible to provide driving in a driving mode suitable for an intended use with a single magnetic disk by switching a through rate while the spindle motor is driven in the pulse-width modulation driving mode according to the application in use such that the spindle motor is driven in the pulse-width modulation driving mode of a high through rate for the use in which a rotation sound is not a serious problem and the spindle motor is driven in the pulse-width modulation driving mode of a low through rate for the use in which the rotation sound is a serious problem.

1. A spindle motor driving method for rotationally driving a spindle motor comprising a rotor having a permanent magnet and a stator having a coil for rotationally driving said rotor by supplying driving current to said coil, the method comprising:
when supplying the driving current to the spindle motor for rotational driving thereof,
switching and selecting a driving mode between a pulse-width modulation driving mode and a linear driving mode according to a command from a higher level system; and
supplying the spindle motor with the driving current corresponding to the driving mode which has been switched and selected between the pulse-width modulation driving mode and the linear driving mode.

2. A spindle motor driving circuit for rotationally driving a spindle motor comprising a rotor having a permanent magnet and a stator having a coil for rotationally driving said rotor by supplying driving current to said coil,
said circuit comprising:
an output stage supplying driving current to said spindle motor for rotational driving thereof; and
driving mode switching means for switching and selecting a driving mode between a pulse-width modulation driving mode and a linear driving mode according to a command from a higher level system,
said output stage being configured such that said driving current, which corresponds to the driving mode switched and selected between said pulse-width modulation driving mode and said linear driving mode by said driving mode switching means, is supplied to said spindle motor.

3. A magnetic disk device, in which a magnetic disk is rotationally driven to record and reproduce a variety of information on said magnetic disk serving as a recording medium of the variety of information, said device comprising:
the spindle motor driving circuit according to claim 2,
said spindle motor driving circuit being configured such that the driving of said output stage is switched between a pulse-width modulation driving mode and a linear driving mode by driving mode switching means according to a command from a higher level system.

4. A spindle motor driving method for rotationally driving a spindle motor comprising a rotor having a permanent magnet and a stator having a coil for rotationally driving said rotor by supplying driving current to said coil, the method comprising:
when supplying the driving current to the spindle motor for rotational driving thereof,
switching and selecting between high and low through rates of a pulse-width modulation driving mode as driving characteristics according to a command from the higher level system; and
supplying to said spindle motor with said driving current corresponding to said through rate switched and selected between said high and low through rates.

5. A spindle motor driving circuit for rotationally driving a spindle motor comprising a rotor having a permanent magnet and a stator having a coil for rotationally driving said rotor by supplying driving current to said coil,
said circuit comprising:
an output stage supplying driving current to said spindle motor for rotational driving thereof; and
through rate switching means for switching and selecting between high and low through rates of a pulse-width modulation driving mode as driving characteristics according to a command from a higher level system,
said output stage being configured such that said driving current, which corresponds to the through rate switched and selected from said high and low through rates by said through rate switching means, is supplied to said spindle motor.

6. A magnetic disk device, in which a magnetic disk is rotationally driven to record and reproduce a variety of information on said magnetic disk serving as a recording medium of the variety of information, said device comprising:
the spindle motor driving circuit according to claim 5,
said spindle motor driving circuit being configured such that a through rate of an output stage driven in a pulse-width modulation driving mode is switched by through rate switching means according to a command from a higher level system.

7. A spindle motor driving method for rotationally driving a spindle motor comprising a rotor having a permanent magnet and a stator having a coil for rotationally driving said rotor by supplying driving current to said coil, the method comprising:
when supplying the driving current to the spindle motor for rotational driving thereof,
switching and selecting a driving mode by a serial port between a pulse-width modulation driving mode and a linear driving mode according to a command from a higher level system that is received via a serial interface; and
supplying to said spindle motor with said driving current corresponding to the driving mode switched and selected between said pulse-width modulation driving mode and said linear driving mode.

8. A spindle motor driving circuit for rotationally driving a spindle motor comprising a rotor having a permanent magnet and a stator having a coil for rotationally driving said rotor by supplying driving current to said coil,
said circuit comprising:
an output stage supplying driving current to said spindle motor for rotational driving thereof; and
driving mode switching means for switching and selecting a driving mode between a pulse-width modulation driving mode and a linear driving mode by a serial port according to a command from a higher level system that is received via a serial interface,
said output stage being configured such that said driving current, which corresponds to the driving mode switched and selected between said pulse-width modulation driving mode and said linear driving mode by said driving mode switching means, is supplied to said spindle motor.

9. A magnetic disk device, in which a magnetic disk is rotationally driven to record and reproduce a variety of information on said magnetic disk serving as a recording medium of the variety of information, said device comprising:
the spindle motor driving circuit according to claim 8,
said spindle motor driving circuit being configured such that a command from a higher level system that is received via a serial interface is sent to a serial port and an output stage is switched by said serial port to be driven by a pulse-width modulation driving mode or a linear driving mode according to said command.

10. A spindle motor driving method for rotationally driving a spindle motor comprising a rotor having a permanent magnet and a stator having a coil for rotationally driving said rotor by supplying driving current to said coil, the method comprising:
when supplying the driving current to the spindle motor for rotational driving thereof,
switching and selecting a driving mode by a serial port between a pulse-width modulation driving mode and a linear driving mode according to a command from a higher level system that is received via a serial interface; and
supplying to said spindle motor with said driving current corresponding to said through rate switched and selected between said high and low through rates.

11. A spindle motor driving circuit for rotationally driving a spindle motor comprising a rotor having a permanent magnet and a stator having a coil for rotationally driving said rotor by supplying driving current to said coil,
said circuit comprising:
an output stage supplying driving current to said spindle motor for rotational driving thereof; and
through rate switching means for switching and selecting between high and low through rates of a pulse-width modulation driving mode by a serial port as driving characteristics according to a command from a higher level system that is received via the serial interface,
said output stage being configured such that said driving current, which corresponds to a through rate switched and selected from said high and low through rates by said through rate switching means, is supplied to said spindle motor.

12. A magnetic disk device, in which a magnetic disk is rotationally driven to record and reproduce a variety of information on said magnetic disk serving as a recording medium of the variety of information, said device comprising:
the spindle motor driving circuit according to claim 11,
said spindle motor driving circuit being configured such that a command from a higher level system that is received via a serial interface is sent to a serial port, and a through rate of an output stage, which is driven in a pulse-width modulation driving mode, is switched by said serial port according to said command.

13. A method of driving a magnetic disk serving as a recording medium of a variety of information, by which in order to record or reproduce the variety of information on said magnetic disk, driving current is supplied to a coil of a spindle motor comprising a rotor having a permanent magnet and a stator having said coil for rotationally driving said rotor, and said magnetic disk is rotationally driven by said spindle motor, the method comprising:
when supplying the driving current to the spindle motor for rotational driving thereof,
switching and selecting a driving mode according to a type of an application in use such that driving in a pulse-width modulation driving mode is performed for a use in which a rotation sound of said spindle motor is not a serious problem for said application, and driving in a linear driving mode is performed for a use in which the rotation sound of said spindle motor is a serious problem for said application; and
supplying said spindle motor with said driving current corresponding to the switched and selected driving mode between said pulse-width modulation driving mode and said linear driving mode.

14. A magnetic disk device comprising a spindle motor including a rotor having a permanent magnet and a stator having a coil for rotationally driving said rotor, a spindle motor driving circuit for rotationally driving said spindle motor by supplying driving current to said coil, and driving mode determining means for determining a driving mode of said spindle motor driving circuit,
said magnetic disk allowing a magnetic disk serving as a recording medium of a variety of information to be rotationally driven by said spindle motor in order to record or reproduce the variety of information on said magnetic disk,
wherein
said driving mode determining means determines the driving mode according to a type of application in use such that driving in a pulse-width modulation driving mode is performed for a use in which a rotation sound of said spindle motor is not a serious problem for said application and driving in a linear driving mode is performed for a use in which the rotation sound of said spindle motor is a serious problem for said application, and
said spindle motor driving circuit includes an output stage supplying the driving current to said spindle motor for rotational driving thereof, and driving mode switching means for switching and selecting said driving mode according to the determination of said driving mode determining means,
said output stage supplying to said spindle motor with said driving current corresponding to a driving mode switched and selected between said pulse-width modulation driving mode and said linear driving mode by said driving mode switching means.

15. A recording medium, wherein as the driving mode determining means of the magnetic disk device according to claim 14, a program is recorded to supply a software for switching a driving mode of said spindle motor according to an application in use, such that said spindle motor is driven in a pulse-width modulation driving mode for a use in which a rotation sound is not a serious problem and said spindle motor is driven in a linear driving mode for a use in which the rotation sound is a serious problem.

16. A method of driving a magnetic disk serving as a recording medium of a variety of information, by which in order to record or reproduce the variety of information on said magnetic disk, driving current is supplied to a coil of a spindle motor comprising a rotor having a permanent magnet and a stator having said coil for rotationally driving said rotor, and said magnetic disk is rotationally driven by said spindle motor, the method comprising:
when supplying the driving current to the spindle motor for rotational driving thereof,
switching and selecting between high and low through rates of a pulse-width modulation driving mode as driving characteristics according to a type of an application in use, such that driving in said pulse-width modulation driving mode of a high through rate is performed for a use in which a rotation sound of said spindle motor is not a serious problem for said application, and driving in said pulse-width modulation driving mode of a low through rate is performed for a use in which the rotation sound of said spindle motor is a serious problem for said application; and
supplying said spindle motor with said driving current corresponding to said through rate switched and selected between said high through rate and said low through rate.

17. A magnetic disk device comprising a spindle motor including a rotor having a permanent magnet and a stator having a coil for rotationally driving said rotor, a spindle motor driving circuit for rotationally driving said spindle motor by supplying driving current to said coil, and through rate determining means for determining driving characteristics of said spindle motor driving circuit,
said magnetic disk allowing a magnetic disk serving as a recording medium of a variety of information to be rotationally driven by said spindle motor in order to record or reproduce the variety of information on said magnetic disk,
wherein
said through rate determining means determines whether a through rate of a pulse-width modulation driving mode is high or low as driving characteristics according to a type of an application in use, such that driving in said pulse-width modulation driving mode of a high through rate is performed for a use in which a rotation sound of said spindle motor is not a serious problem for said application, and driving in said pulse-width modulation driving mode of a low through rate is performed for a use in which the rotation sound of said spindle motor is a serious problem for said application, and
said spindle motor driving circuit includes an output stage which supplies a driving current to said spindle motor for rotational driving thereof, and through rate switching means for switching and selecting between high and low through rates of said pulse-width modulation driving mode as driving characteristics according to the determination of said through rate determining means,
said output stage supplying to said spindle motor with said driving current corresponding to a through rate switched and selected between said high through rate and said low through rate by said through rate switching means.

18. A recording medium, wherein as through rate determining means of said magnetic disk device according to claim 17, a program is recorded to supply a software for switching a through rate of an output stage driven in a pulse-width modulation driving mode according to an application in use, such that a spindle motor is driven in said pulse-width modulation driving mode of a high through rate for a use in which a rotation sound is not a serious problem and said spindle motor is driven in said pulse-width modulation driving mode of a low through rate for a use in which the rotation sound is a serious problem.
